(19) United States
(12) Patent Application Publication
(10) Pub. No.: US 2016/0368385 A1
(43) Pub. Date: Dec. 22, 2016

(54) DEVICE AND METHOD FOR CONTROLLING BIDIRECTIONAL CONVERTER OF ECO-FRIENDLY VEHICLE

(71) Applicant: Hyundai Motor Company, Seoul (KR)

(72) Inventors: Jeong Bin Yim, Anyang (KR); Jae Hwa Jeon, Hwaseong (KR); Dae Woong Han, Anyang (KR); Sang Kyu Lee, Yongin (KR)

(21) Appl. No.: 14/959,324

(22) Filed: Dec. 4, 2015

(30) Foreign Application Priority Data
Jun. 17, 2015 (KR) 10-2015-0085553

(51) Int. Cl. B60L 11/18; H02M 7/797; H02M 7/44

(52) U.S. Cl. CPC B60L 11/18; H02M 7/44; H02M 7/797

(57) ABSTRACT

In a device and method for controlling a bidirectional converter of an eco-friendly vehicle, the bidirectional converter in a non-load or low load area is not operated in a bidirectional mode (or buck-boost mode) but operated in an optimum mode selected from a bypass mode, a buck mode, and a boost mode, so that it is possible to reduce power loss of the bidirectional converter and improve system efficiency.

### CROSS-REFERENCE TO RELATED APPLICATION

This application claims under 35 U.S.C. §119(a) the benefit of Korean Patent Application No. 10-2015-0085553 filed on Jun. 17, 2015, the entire contents of which are incorporated herein by reference.

### BACKGROUND

(a) Technical Field

The present invention relates to a device and a method for controlling a bidirectional converter of an eco-friendly vehicle, more particularly, to a device and a method for controlling a bidirectional converter of an eco-friendly vehicle, which can efficiently optimally control an operation of a bidirectional converter mounted between a high-voltage battery and an inverter, thereby reducing power loss.

(b) Description of the Related Art

In general, an eco-friendly vehicle such as a hybrid electric vehicle or an electric vehicle, which uses an electric motor as a driving source, is equipped with a high-voltage battery as a power source of the electric motor, and an inverter for driving the electric motor by converting an output of the high-voltage battery is mounted between the high-voltage battery and the electric motor.

A high-voltage DC-DC converter (HDC) mounted between the high-voltage battery and the inverter functions to boost a voltage of the high-voltage battery and supply the boosted voltage to a motor system (including the electric motor and the inverter). The topology frequently used in the HDC operates as a buck-boost converter regardless of the direction of current, and hence is also referred to as a bidirectional converter.

### SUMMARY

The present invention provides a device and a method for controlling a bidirectional converter of an eco-friendly vehicle, in which the bidirectional converter in a non-load or low load area is not operated in a bidirectional mode (or buck-boost mode) but operated in an optimum mode selected from a bypass mode, a buck mode, and a boost mode, so that it is possible to reduce power loss of the bidirectional converter and improve system efficiency.

In one aspect, the present invention provides a device for controlling a bidirectional converter of an eco-friendly vehicle, the device including: a high voltage battery configured to supply power for driving an electric motor; an inverter configured to convert power of the bidirectional converter and supply the converted power to the electric motor; the bidirectional converter mounted between the battery and the inverter, the bidirectional converter boosting a voltage of the battery and supplying the boosted voltage to the inverter, or bucking a voltage input from the inverter and supplying the bucked voltage to the battery; and a controller configured to divide a load of the bidirectional converter into a plurality of areas and control the bidirectional converter in different operation modes for the respective areas.

In an exemplary embodiment, the controller may divide the load of the bidirectional converter into a non-load area in which power loss is generated when the bidirectional converter is operated, a low load area in a positive direction, in which when the bidirectional converter is operated in a buck-boost mode, a considerable amount of power loss is generated as compared with when the bidirectional converter is operated in a boost mode, a low load area in a negative direction, in which when the bidirectional converter is operated in the buck-boost mode, a considerable amount of power loss is generated as compared with when the bidirectional converter is operated in a buck mode, a high load area in the positive direction, in which when the bidirectional converter is operated in the boost mode, a considerable amount of power loss is generated as compared with when the bidirectional converter is operated in the buck-boost mode, and a high load area in the negative direction, in which when the bidirectional converter is operated in the buck mode, a considerable amount of power loss is generated as compared with when the bidirectional converter is operated in the buck-boost mode.

In another exemplary embodiment, when a load of the bidirectional converter belongs to a non-load area, the controller may operate the bidirectional converter in a bypass mode to supply the voltage of the battery to the inverter without any change.

In still another exemplary embodiment, when the load of the bidirectional converter belongs to a low load area in a positive direction, the controller may operate the bidirectional converter in a boost mode to boost the voltage of the battery and supply the boosted voltage to the inverter.

In yet another exemplary embodiment, when the load of the bidirectional converter belongs to a low load area in a negative direction, the controller may operate the bidirectional converter in a buck mode to buck the voltage input from the inverter and supply the bucked voltage to the battery.

In still yet another exemplary embodiment, when the load of the bidirectional converter belongs to high load areas in positive and negative directions, the controller may operate the bidirectional converter in a buck-boost mode.

In another aspect, the present invention provides a method for controlling a bidirectional inverter of an eco-friendly vehicle, which is mounted between a battery and an inverter to boost a voltage of the battery and supply the boosted voltage to the inverter or to buck a voltage input from the inverter and supply the bucked voltage to the battery, the method including: a first process of detecting a load of the bidirectional converter; and a second process of detecting load areas to which the load of the bidirectional converter, detected in the first process, belongs, and controlling an operation mode of the bidirectional converter for each of the detected load areas.

In another aspect, a non-transitory computer readable medium containing program instructions executed by a processor can include: program instructions that detect a load of the bidirectional converter; and program instructions that detect load areas to which the detected load of the bidirectional converter belongs, and controlling an operation mode of the bidirectional converter for each of the detected load areas.

Other aspects and exemplary embodiments of the invention are discussed infra.

According to the present invention, the bidirectional converter in the non-load or low load area is not operated in the bidirectional mode (or buck-boost mode) but operated in an optimum mode selected from the bypass mode, the buck mode, and the boost mode, so that it is possible to reduce power loss of the bidirectional converter and improve system efficiency.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram illustrating a bidirectional converter of an eco-friendly converter;

FIG. 2 is a schematic diagram illustrating a buck-boost operation of the bidirectional converter;

FIG. 3 is a schematic diagram illustrating a device for controlling a bidirectional converter of an eco-friendly vehicle according to an embodiment of the present invention;

FIG. 4 is a conceptual diagram illustrating a method for controlling the bidirectional converter of the eco-friendly vehicle according to an embodiment of the present invention;

FIG. 5 is a graph illustrating a loss amount for each operation mode based on a load of the bidirectional converter according to the present invention;

FIG. 6 is a graph illustrating advantages of the device according to the present invention;

FIG. 7 is a schematic diagram illustrating advantages of the device according to the present invention; and

FIG. 8 is a flowchart illustrating the method according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

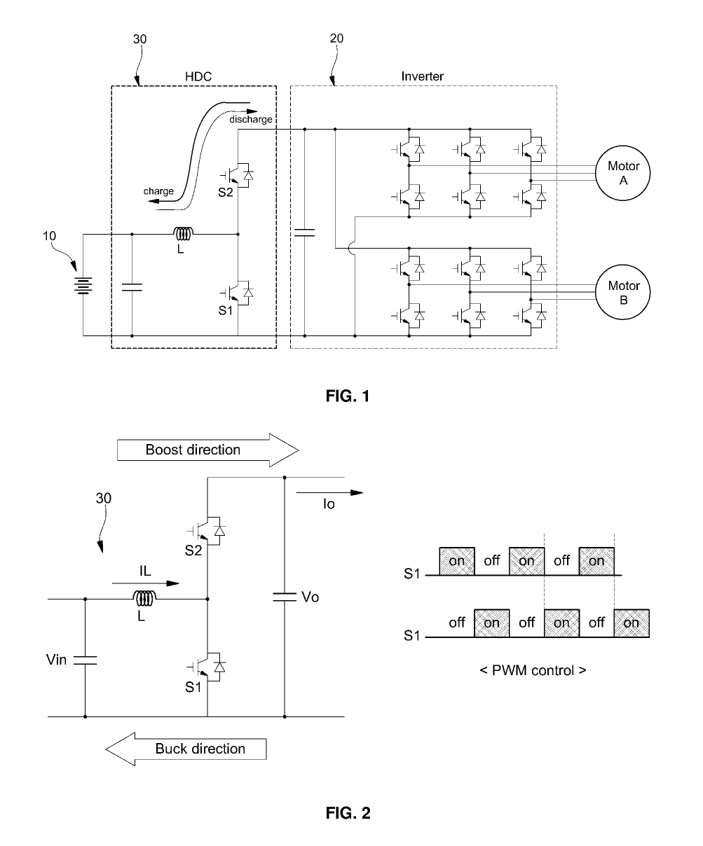

FIG. 1 is a diagram illustrating a bidirectional converter of an eco-friendly converter, and FIG. 2 is a diagram illustrating a buck-boost operation of the bidirectional converter.

As shown in FIG. 1, the bidirectional converter, i.e., a high-voltage DC-DC converter (or HDC) 30, is a converter which is mounted between a high-voltage battery 10 and an inverter (or motor system) 20 to boost a voltage of the high-voltage battery 10.

If the bidirectional converter 30 boosts the voltage of the high-voltage battery 10, then power (P) equals voltage (V) times electric current (I), or P=VI, even though the motor system (including an electric motor and the inverter) outputs the same power as before the voltage of the high-voltage battery is boosted, and therefore, the amount of consumed current is decreased. Thus, the power loss (PLoss) in the motor system is PLoss=Î2*R, which is in proportion to the square of current. Hence, the power loss is reduced, and the system efficiency is improved.

A buck-boost operation method of the bidirectional converter will be described with reference to FIG. 2. A first switching element S1 and a second switching element S2, which constitute a circuit of the bidirectional converter 30, perform on/off operations under pulse width modulation (PWM) control in the buck-boost operation of the bidirectional converter 30. The first switching element S1 and the second switching element S2 always perform on/off operations opposite to each other under the PWM control.

Specifically, an output voltage Vo of the bidirectional converter 30 in a buck mode operation is Vo=Vin/(1−D1), and an input voltage Vin of the bidirectional converter 30 in a boost mode operation is Vin=Vo*D2. Therefore, if D2=1−D1, i.e., if the first switching element S1 and the second switching element S2 always perform on/off operations opposite to each other, output voltages Vo of the bidirectional converter 30 in the buck mode operation and the boost mode operation are unified as Vo=Vin/(1−D1).

Here, D1 is a PWM duty of the first switching element S1, and D2 is a PWM duty of the second switching element S2.

Although the bidirectional converter operated as described above is in a non-load (output current Io=0) or low load state, a considerable amount of current IL flowing through an inductor constituting the circuit of the bidirectional converter exists. Hence, loss in the non-load or low load state of the bi-directional converter is excessively generated as compared with a general buck converter (buck converting circuit) or boost converter (boost converting circuit). Specifically, core loss and power loss of the inductor, power loss and switching loss of the switching element, and the like are excessively generated.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

First, as shown in FIG. 3, a configuration of a circuit of a bidirectional converter 30 is illustrated as a structure for power conversion between an electric motor 40, used as a driving source of an eco-friendly vehicle, and a high-voltage battery 10, used as a power source of the electric motor 40. Also, a connection state of the high-voltage battery 10, an inverter 20, and the electric motor 40 is illustrated. In FIG. 3, an example is illustrated in which the inverter 20 includes two inverters 21 and 22, and the motor 40 includes two electric motors 41 and 42 driven by the respective inverters 21 and 22.

The bidirectional converter 30 includes, as main components, switching elements S1 and S2 for controlling a supply of power and an inductor L, and operations of the switching elements S1 and S2 are controlled according to a control signal applied from a controller 50.

The high-voltage battery 10, which supplies power for driving the electric motor 40, is connected to an input terminal of the bidirectional converter 30, and the inverter 20, which converts and outputs power output from the bidirectional converter 30 so as to drive the electric motor 40, is connected to an output terminal of the bidirectional converter 30.

The bidirectional converter 30 is mounted between the high-voltage battery 10 and the inverter 20, to perform an operation of boosting power input from the high voltage battery 10 to drive the electric motor 40 and supplying the boosted power to the inverter 20, an operation of supplying power input to the output terminal (or supplied from the inverter 20) to the high-voltage battery to be chargeable, or the like.

In order to perform the operation, the controller 50 which controls switching (on/off) operations of a first switching element S1 and a second switching element S2, constituting the circuit of the bidirectional converter 30, is connected to the bidirectional converter 30.

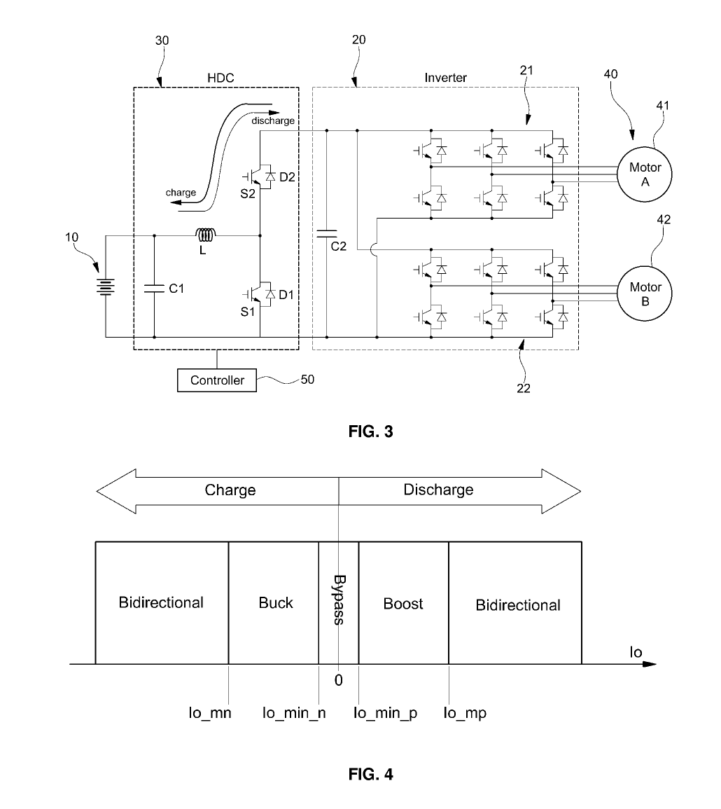

As shown in FIG. 4, the controller 50 divides a load of the bidirectional converter 30 (output current Io) into a plurality of areas (sections), and controls the bidirectional converter 30 in different operation modes for the respective areas of the load.

Specifically, the controller 50 divides the load of the bidirectional converter 30 into a non-load area, a low load area in a positive direction (or forward direction), a low load area in a negative direction (reverse direction), a high load area in the positive direction (or forward direction), and a high load area in the negative direction (or reverse direction), and optimally controls an operation of the bidirectional converter 30 for each load area.

The non-load area is a section (section Io_min_n to Io_min_p of FIG. 4) in which the load of the bidirectional converter 30 has a minimum value of the output current Io, which is approximately equal to 0. In the non-load area, it can be considered that it is unnecessary to boost or buck an output of the high-voltage battery 10, and hence a transformation operation of the bidirectional converter 30 is unnecessary.

Thus, when it is determined that the load of the bidirectional converter 30 belongs to (is included in) the non-load area of the bidirectional converter 30, the controller 50 allows the first switching element S1 of the bidirectional converter 30 to perform an off operation, and allows the second switching element S2 of the bidirectional converter 30 to perform an on or off operation, so that the bidirectional converter 30 is operated in a bypass mode.

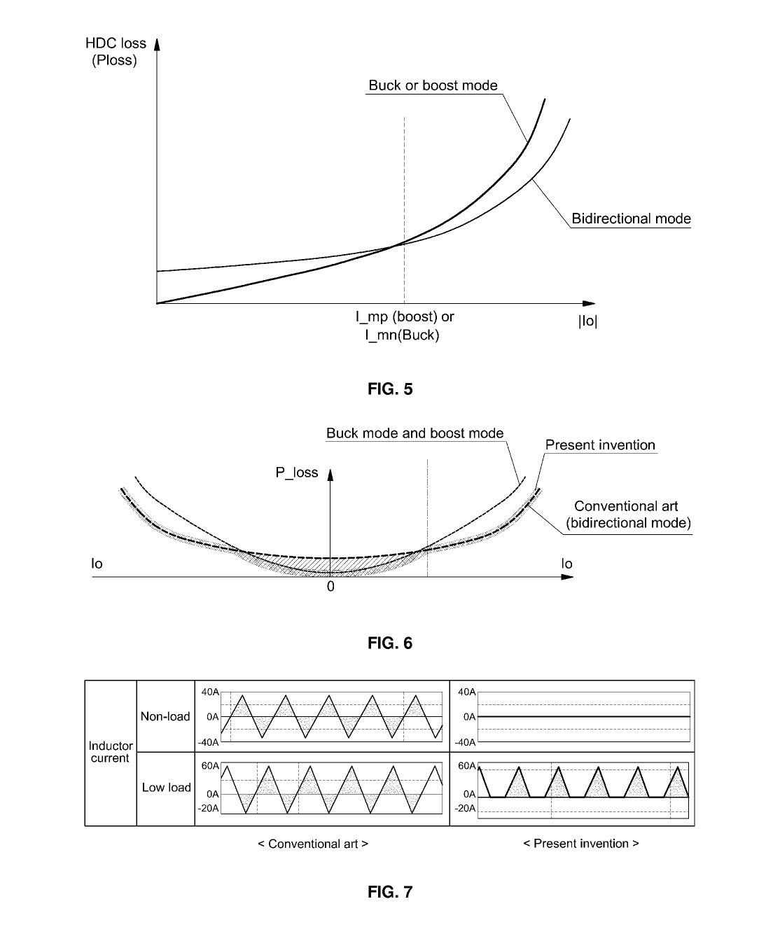

The low load area in the positive direction is a section (section Io_min_p to Io_mp of FIG. 4) in which the load of the bidirectional converter 30 has a value of the output current Io, which is greater than the non-load area of the bidirectional converter 30 and smaller than the high load area in the positive direction. In the low load area, the bidirectional converter 30 boosts power of the high-voltage battery 10 and outputs the boosted power, thereby reducing loss (see FIG. 5).

Thus, when it is determined that the load of the bidirectional converter 30 belongs to (is included in) the low load area in the positive direction, the controller 50 allows the second switching element S2 of the bidirectional converter 30 to perform an off operation, and controls on/off operations of the first switching element S1 of the bidirectional converter 30 in a pulse width modulation (PWM) manner, so that the bidirectional converter 30 is operated in a boost mode.

In this case, the bidirectional converter 30 boosts power of the high-voltage battery 10 and outputs the boosted power, and the high-voltage battery 10 is discharged.

The low load area in the negative direction is a section (section Io_min_n to Io_mn of FIG. 4) in which the load of the bidirectional converter 30 has a value of the output current Io, which is smaller than the non-load area and greater than the high load area in the negative direction. In the low load area, the bidirectional converter 30 bucks power input from the inverter 20 and outputs the bucked power to the high-voltage battery 10, thereby reducing loss (see FIG. 5).

Thus, when it is determined that the load of the bidirectional converter 30 belongs to (is included in) the low load area in the negative direction, the controller 50 allows the first switching element S1 of the bidirectional converter 30 to perform an off operation, and controls on/off operations of the second switching element S2 of the bidirectional converter 30 in the PWM manner, so that the bidirectional converter 30 is operated in a buck mode.

In this case, the bidirectional converter 30 bucks power input from the inverter 20 so as to charge the high-voltage battery 10 and outputs the bucked power to the high-voltage battery 10, and the high-voltage battery 10 is charged.

The high-load area in the positive direction (or middle load and high load areas in the positive direction) is a section (section Io>Io_mp of FIG. 4) in which the load of the bidirectional converter 30 has a value of the output current Io, which is greater than the low load area in the positive direction. In the high load area, the bidirectional converter 30 performs an operation of boosting power of the high-voltage battery 10 and outputting the boosted power in a bidirectional mode in which the first switching element S1 and the second switching element S2 alternately perform on/off operations (see FIG. 2), thereby reducing loss (see FIG. 5).

In other words, in the high load area in the positive direction, the bidirectional converter 30 controls the first switching element S1 and the second switching element S2 in the PWM manner. Preferably, the bidirectional converter 30 boosts power of the high-voltage battery 10 and outputs the boosted power in the bidirectional mode in which the first switching element S1 and the second switching element S2 alternately perform on/off operations.

The high-load area in the negative direction (or middle load and high load areas in the negative direction) is a section (section Io<Io_mn of FIG. 4) in which the load of the bidirectional converter 30 has a value of the output current Io, which is smaller than the low load area in the negative direction. In the high load area, the bidirectional converter 30 performs an operation of bucking power input from the inverter 20 and outputting the bucked power in the bidirectional mode in which the first switching element S1 and the second switching element S2 alternately perform on/off operations, thereby reducing loss (see FIG. 5).

Thus, when it is determined that the load of the bidirectional converter 30 belongs to (is included in) the high load area in the positive direction or when it is determined that the load of the bidirectional converter 30 belongs to (is included in) the high load area in the negative direction, the controller 50 controls the first switching element S1 and the second switching element S2 in the PWM manner, so that the bidirectional converter 30 is operated in a buck-boost mode (i.e., the bidirectional mode).

The operation modes of the bidirectional converter 30 for the respective areas and the operations of the switching elements S1 and S2 will be summarized as shown in the following Table 1.

TABLE 1

| | Area of Load | | | | |
|---|---|---|---|---|---|
| | | Io_min_n | Io_min_n | Io_min_p | |
| | | to | to | to | |
| | Io_mn↓ | Io_mn | Io_min_p | Io_mp | Io_mp↑ |
| Mode | Bidirec- | Buck | Bypass | Boost | Bidirec- |
| | tional | | | | tional |
| S1 | PWM | OFF | OFF | PWM | PWM |
| S2 | PWM | PWM | ON (or | OFF | PWM |
| | | | OFF) | | |

Meanwhile, as shown in FIG. 5, the amount of power loss according to the load (output current Io) in overall sections of the load of the bidirectional converter is illustrated as a graph (loss graph) for each operation mode. In this case, an intersecting point is generated between the loss graphs in the buck mode and the bidirectional mode or between the loss graphs in the boost mode and the bidirectional mode. Based on the intersecting point (loss turning point or efficiency turning point), a mode in which the amount of power loss is relatively increased between the buck mode and the bidirectional mode or between the boost mode and the bidirectional mode is changed.

In this case, a value of the output current Io at one of the loss turning points, which is generated in the load section in the positive direction, is determined as Io_mp, and a value of the output current Io at the other of the loss turning points, which is generated in the load section in the negative direction, is determined as Io_mn.

More specifically, when the bidirectional converter 30 is operated in the buck mode, the first switching element S1 is in the off state, and therefore, current applied to the first switching element S1 flows through a diode of the first switching element S1. In this case, the conduction loss of the diode is greater than the conduction loss in the on operation of the first switching element S1. Hence, an intersecting point (loss turning point or efficiency turning point) is generated between the loss graph in the buck mode and the loss graph in the bidirectional mode according to the amount of increase in the load of the bidirectional converter 30, and the value of the output current Io at the intersecting point is determined as Io_mn.

When the bidirectional converter 30 is operated in the boost mode, the second switching element S2 is in the off state, and therefore, current applied to the second switching element S2 flows through a diode of the second switching element S2. In this case, the conduction loss of the diode is greater than the conduction loss in the on operation of the second switching element S2. Hence, an intersecting point (loss turning point or efficiency turning point) is generated between the loss graph in the boost mode and the loss graph in the bidirectional mode according to the amount of increase in the load of the bidirectional converter 30, and the value of the output current Io at the intersecting point is determined as Io_mp.

That is, Io_mp is determined as a value of the output current Io at an efficiency turning point (or loss turning point) between the bidirectional mode and the boost mode, and Io_mn is determined as a value of the output current Io at an efficiency turning point (or loss turning point) between the bidirectional mode and the buck mode.

Io_min_p and Io_min_n are switching points of the boost mode and the buck mode, respectively. When the bidirectional converter is operated in any one of the boost mode, the buck mode, and the buck-boost (bidirectional) mode in the section Io_min_n to Io_min_p, power loss is generated in any one of the boost mode, the buck mode, and the buck-boost (bidirectional) mode.

That is, minimum and maximum values in a load section in which power loss is generated when the bidirectional converter is operated in any one of the boost mode, the buck mode, and the buck-boost (bidirectional) mode are determined as Io_min_n and Io_min_p, respectively.

In order to obtain an advantage (benefit in terms of the entire efficiency of a motor system) in which power output to the motor system (including the electric motor and the inverter) is boosted, the controller 50 minimizes the section Io_min_n to Io_min_p, which is set as the non-load area.

Generally, the controller 50 receives torque command information from a high-level controller (not shown) which outputs a torque command of the electric motor 40, and calculates the amount of power of the electric motor 40 by detecting the torque and rotational speed of the electric motor 40 from the torque command information. The controller 50 estimates a load (output current Io) of the bidirectional converter 30, based on the calculated amount of power of the electric motor 40. The controller 50 controls the operation mode of the bidirectional converter 30 by considering a load area to which the estimated load belongs.

As described above, in the device according to the present invention, the bidirectional converter 30 in the non-load or low load area is not operated in the buck-boost mode but operated in an optimum mode selected from the bypass mode, the buck mode, and the boost mode, so that it is possible to reduce loss corresponding to a slashed portion as shown in FIG. 6. Also, as shown in FIG. 7, it is possible to prevent the generation of inductor current in the non-load area and remove loss (core loss and power loss of the inductor, power loss and switching loss of the switching element, etc.) in the non-load area by reducing inductor current in the low load area. Also, it is possible to improve efficiency in the low load area by reducing loss in the low load area.

Here, a method for controlling the bidirectional converter configured as described above according to the present invention will be described as follows.

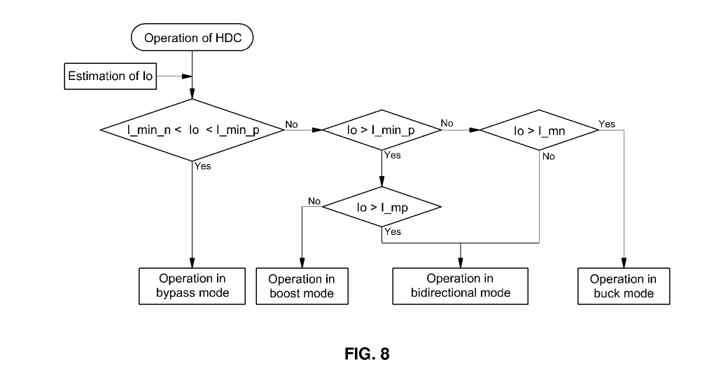

As shown in FIG. 8, when the bidirectional converter 30 is operated, the controller 50 estimates a load (output current Io) of the bidirectional converter 30, based on a motor torque command received from the high-level controller (not shown).

The controller 50 detects a load area to which the estimated load of the bidirectional converter 30 belongs, and controls the operation of the bidirectional converter 30 in an operation mode set in the detected load area.

That is, the controller 50 controls the bidirectional converter 30 in different operation modes for the respective load areas to which the load of the bidirectional converter 30 belongs.

As described above, if it is determined that the load of the bidirectional converter 30 belongs to the non-load area, the controller 50 operates the bidirectional converter 30 in the bypass mode. If it is determined that the load of the bidirectional converter 30 belongs to the low load area in the positive direction, the controller 50 operates the bidirectional converter 30 in the boost mode. If it is determined that the load of the bidirectional converter 30 belongs to the low load area in the negative direction, the controller 50 operates the bidirectional converter 30 in the buck mode. If it is determined that the load of the bidirectional converter 30 belongs to the high load areas in the positive and negative directions, the controller 50 operates the bidirectional converter 30 in the buck-boost mode (bidirectional mode).

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A device for controlling a bidirectional converter of an eco-friendly vehicle, the device comprising:
a battery configured to supply power for driving an electric motor;
an inverter configured to convert power of the bidirectional converter and supply the converted power to the electric motor;
the bidirectional converter mounted between the battery and the inverter, the bidirectional converter boosting a voltage of the battery and supplying the boosted voltage to the inverter, or bucking a voltage input from the inverter and supplying the bucked voltage to the battery; and
a controller configured to divide a load of the bidirectional converter into a plurality of areas and control the bidirectional converter in different operation modes for the respective areas.

2. The device of claim 1, wherein when the load of the bidirectional converter belongs to a non-load area, the controller operates the bidirectional converter in a bypass mode to supply the voltage of the battery to the inverter without any change.

3. The device of claim 1, wherein when the load of the bidirectional converter belongs to a low load area in a positive direction, the controller operates the bidirectional converter in a boost mode to boost the voltage of the battery and supply the boosted voltage to the inverter.

4. The device of claim 1, wherein when the load of the bidirectional converter belongs to a low load area in a negative direction, the controller operates the bidirectional converter in a buck mode to buck the voltage input from the inverter and supply the bucked voltage to the battery.

5. The device of claim 1, wherein when the load of the bidirectional converter belongs to high load areas in positive and negative directions, the controller operates the bidirectional converter in a buck-boost mode.

6. A method for controlling a bidirectional inverter of an eco-friendly vehicle, which is mounted between a battery and an inverter to boost a voltage of the battery and supply the boosted voltage to the inverter or to buck a voltage input from the inverter and supply the bucked voltage to the battery, the method comprising:
a first process of detecting a load of the bidirectional converter; and
a second process of detecting load areas to which the load of the bidirectional converter, detected in the first process, belongs, and controlling an operation mode of the bidirectional converter for each of the detected load areas.

7. The method of claim 6, wherein in the second process, when the load of the bidirectional converter belongs to a low load area in a positive direction, the bidirectional converter is operated in a boost mode to boost the voltage of the battery and supply the boosted voltage to the inverter.

8. The method of claim 6, wherein in the second process, when the load of the bidirectional converter belongs to a low load area in a negative direction, the bidirectional converter is operated in a buck mode to buck the voltage input from the inverter and supply the bucked voltage to the battery.

9. The method of claim 6, wherein in the second process, when the load of the bidirectional converter belongs to high load areas in positive and negative directions, the bidirectional converter is operated in a buck-boost mode.

10. A non-transitory computer readable medium containing program instructions executed by a processor, the computer readable medium comprising:
program instructions that detect a load of the bidirectional converter; and
program instructions that detect load areas to which the detected load of the bidirectional converter belongs, and controlling an operation mode of the bidirectional converter for each of the detected load areas.

11. The computer readable medium of claim 10, wherein when the load of the bidirectional converter belongs to a low load area in a positive direction, the bidirectional converter is operated in a boost mode to boost the voltage of the battery and supply the boosted voltage to the inverter.

12. The computer readable medium of claim 10, wherein when the load of the bidirectional converter belongs to a low load area in a negative direction, the bidirectional converter is operated in a buck mode to buck the voltage input from the inverter and supply the bucked voltage to the battery.

13. The computer readable medium of claim 10, wherein when the load of the bidirectional converter belongs to high load areas in positive and negative directions, the bidirectional converter is operated in a buck-boost mode.
